(19) United States
(12) Patent Application Publication
(10) Pub. No.: US 2014/0203899 A1
(43) Pub. Date: Jul. 24, 2014

(54) ELECTROMAGNET, MOTOR AND SOLENOID

(71) Applicants: Furukawa Magnet Wire Co., Ltd., Tokyo (JP); Furukawa Electric Co., Ltd., Tokyo (JP)

(72) Inventors: Kengo TANAKA, Tokyo (JP); Noriyoshi FUSHIMI, Tokyo (JP)

(73) Assignees: Furukawa Magnet Wire Co., Ltd., Tokyo (JP); Furukawa Electric Co., Ltd., Tokyo (JP)

(21) Appl. No.: 14/227,614

(22) Filed: Mar. 27, 2014

Related U.S. Application Data
(63) Continuation of application No. PCT/JP2011/072429, filed on Sep. 29, 2011.

(51) Int. Cl. H01F 7/06; H01F 7/08; H02K 3/02

(52) U.S. Cl. CPC H01F 7/06; H02K 3/02; H01F 7/081
USPC 335/255; 335/299; 310/179

(57) ABSTRACT

An electromagnet includes a core and a wire wound on the core. The wire includes an electric conductor and a magnetic layer provided on a surface of the electric conductor.

### CROSS REFERENCE TO RELATED APPLICATIONS

This is a continuation application of International Patent Application No. PCT/JP2011/072429 filed Sep. 29, 2011, the full content of which is hereby incorporated by reference in its entirety.

### BACKGROUND

1. Technical Field

The present disclosure relates to an electromagnet of a motor, a disc brake, a solenoid, a generator, or the like.

2. Background

In the related art, an electromagnet in which a winding is wound around a core is used for acquiring a rotational force of a motor or an open-close force of a brake. As a wire rod for a winding, a wire rod having an insulating layer provided outwardly of an electrical conductor (core) such as copper is commonly used.

Although not a wire rod for an electromagnet, a wire rod having a magnetic material plated on a surface of such an electrical conductor is also known. It has been reported that, with an inductor that uses such a wire rod, there is an increase in an inductance of about 10% in a 1 MHz frequency band (e.g., see Japanese Laid-open Patent Publication No. S62-211904).

However, a performance, such as an attractive force, of the aforementioned electromagnet does not always improve along with an increase in an inductance. For example, regarding an electromagnet of a disc brake, an increase in an inductance does not always directly lead to an improvement in the opening-and-closing force of the brake. Also, regarding a motor, an increase in an inductance does not always directly lead to an improvement in a motor torque.

It is an object of the present disclosure to provide, by taking into the aforementioned background into consideration, an electromagnet that can improve an output of an apparatus using the electromagnet.

### SUMMARY

In order to achieve the above mentioned object, according to the present disclosure, a wire rod for electromagnet used for a coil of an electromagnet that produces a magnetic field when an electric current is flowing therethrough is provided and the wire rod for electromagnet includes a magnetic layer provided on a surface layer of an electric conductor.

Further, the magnetic layer may have a film thickness of greater than 0 μm and less than or equal to 6.0 μm and a saturation magnetic flux density of 0.75 T to 2.15 T.

Further preferably, the magnetic layer has a film thickness of greater than 0 μm and less than or equal to 3.0 μm and a saturation magnetic flux density of 0.75 T to 2.15 T.

Further, the magnetic layer may have a film thickness of greater than 0 μm and less than or equal to 6.0 μm and a saturation magnetic flux density of 1.5 T to 2.15 T.

Further preferably, the magnetic layer has a film thickness of greater than 0 μm and less than or equal to 3.0 μm and a saturation magnetic flux density of 1.5 T to 2.15 T.

Further preferably, the magnetic layer has a film thickness of 3.0 μm to 9.0 μm and an initial permeability of 500 to 2000.

Further, the magnetic layer may consist of an alloy of two or more elements, the alloy containing Fe of greater than or equal to 10% by weight.

Further, the magnetic layer may be made of an Fe-50Ni alloy. Further, the magnetic layer is made of an Fe-80Ni alloy.

On the other hand, the magnetic layer of an Fe-50Ni alloy may have a film thickness of 1.0 μm to 9.0 μm, and preferably 3.0 μm to 9.0 μm, and further preferably 6.0 μm to 9.0 μm. Also, the magnetic layer may have an initial permeability of 500 to 2000.

Also, the magnetic layer of Fe-80Ni alloy may have a film thickness of 2.0 μm to 9.0 μm, and preferably 3.0 μm to 9.0 μm, and further preferably 6.0 pm to 9.0 μm. Also, the magnetic layer may have an initial permeability of 500 to 2000.

Further, the magnetic layer may be made of an alloy mainly containing Fe and may have a film thickness of greater than 0 μm and less than or equal to 6.0 μm, and further preferably, greater than 0 μm and less than or equal to 3.0 μm.

Further, the magnetic layer may be substantially made of Fe.

Further, the magnetic layer substantially made of Fe may have a film thickness of greater than 0 μm and less than or equal to 3.0 μm, and preferably a film thickness of 1.5 μm to 3.0 μm.

Further, the magnetic layer may be provided between the electric conductor and an insulating layer.

Further, a coil according to the present disclosure is constituted by winding a wire rod for electromagnet.

A wire rod for electromagnet of the present disclosure is a wire rod for electromagnet used for a coil of an electromagnet that produces a magnetic field when an electric current is flowing therethrough that includes a magnetic layer provided on a surface layer of an electric conductor, and thus an electromagnetic force of the electromagnet can be improved. Accordingly, an attractive force of the solenoid can be increased, and, for example, when applied to a brake, an open-close force (attractive force) of the brake can be improved.

### BRIEF DESCRIPTION OF DRAWINGS

FIG. 1 is a cross-sectional view schematically showing a configuration of a wire rod for electromagnet of a first embodiment of the present disclosure.

FIGS. 2A and 2B are cross-sectional views of a wire rod for electromagnet for a case where a flat rectangular wire is used.

FIG. 3 is a cross-sectional view of a solenoid for testing an attractive force of an electromagnet.

FIG. 4 is a graph showing a relationship between a film thickness of the magnetic layer and a rate of change of attractive force in an attractive force examination using the solenoid of FIG. 3.

FIG. 5 is a schematic view showing a case in which a wire rod for electromagnet is used in a stator of a concentrated winding motor.

FIGS. 6A and 6B are schematic views showing a case in which a wire rod for electromagnet is used in a stator of a distributed winding motor.

FIG. 7 is a cross-sectional view schematically showing a configuration of a wire rod for electromagnet of a second embodiment of the present disclosure.

FIG. 8 is a cross-sectional view of a solenoid for examining an attractive force of an electromagnet.

FIG. 9A is a graph showing a relationship between an electric current and an attractive force in an attractive force examination using the solenoid of

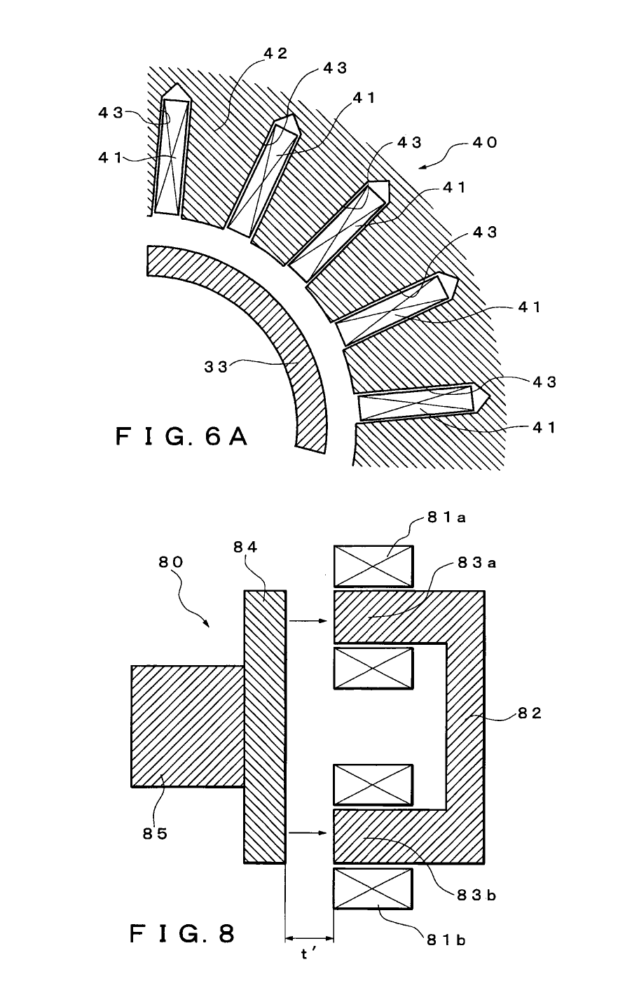

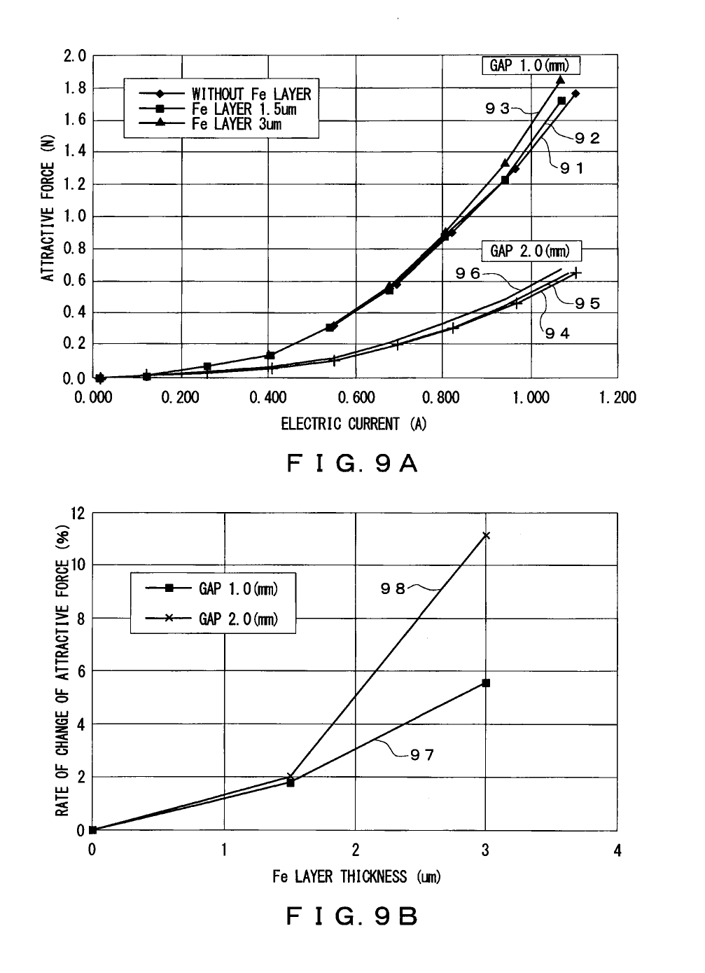

FIG. 8, and FIG. 9B is a graph showing a relationship between a film thickness of the magnetic layer and a rate of change of attractive force.

### DETAILED DESCRIPTION

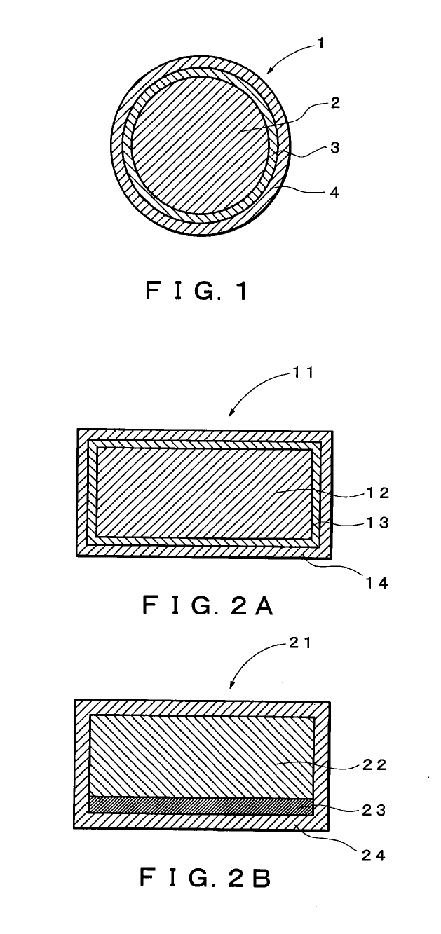

Hereinafter, a wire rod for electromagnet 1 of an embodiment of the present disclosure will be described with reference to the drawings. FIG. 1 is a cross-sectional view showing a configuration of a wire rod for electromagnet 1 of a first embodiment of the present disclosure.

The wire rod for electromagnet 1 includes an electric conductor 2 that is a core of the wire rod, a magnetic layer 3 that covers an outer side of the electric conductor 2 and an insulating layer 4 that covers a further outer periphery of the magnetic layer 3 (i.e., the magnetic layer 3 is provided between the electric conductor 2 and the insulating layer 4).

The electric conductor 2 has a circular cross-section and is made of copper which is a conductive material.

The magnetic layer 3 is conductive and formed to have a thickness of an order of a few to several μm. The magnetic layer 3 is formed by a plating or the like in such a manner that it uniformly covers an entire outer periphery of the electric conductor 2. Regarding the material of the magnetic layer 3, the magnetic layer 3 is made of an alloy of two or more elements that contains Fe of greater than or equal to 10% by weight. Preferably, the magnetic layer 3 is made of an Fe-50Ni alloy or an Fe-80Ni alloy.

The insulating layer 4 is, for example, an enamel insulating layer, and has a thickness of approximately 35 μm.

As shown in FIGS. 2A and 2B, the wire rod for electromagnet can be configured as a flat rectangular wire.

A wire rod for electromagnet 11 shown in FIG. 2A includes an electric conductor 12, that is a core of the wire rod, having a rectangular cross-section and a magnetic layer 13 formed to cover an outer side in its entirety on four sides thereof. Also, an insulating layer 14 is formed outwardly of the magnetic layer 13 to cover an outer side in its entirety of the magnetic layer 13. Such a flat rectangular wire is advantageous in that it can be wound without gaps being produced between adjacent wire rods when winding the wire rod around the core.

A wire rod for electromagnet 21 shown in FIG. 2B includes a magnetic layer 23 that is formed only at a position below a bottom side of the electric conductor 22 having a rectangular cross-section. An insulating layer 24 is formed to cover them on an outer side.

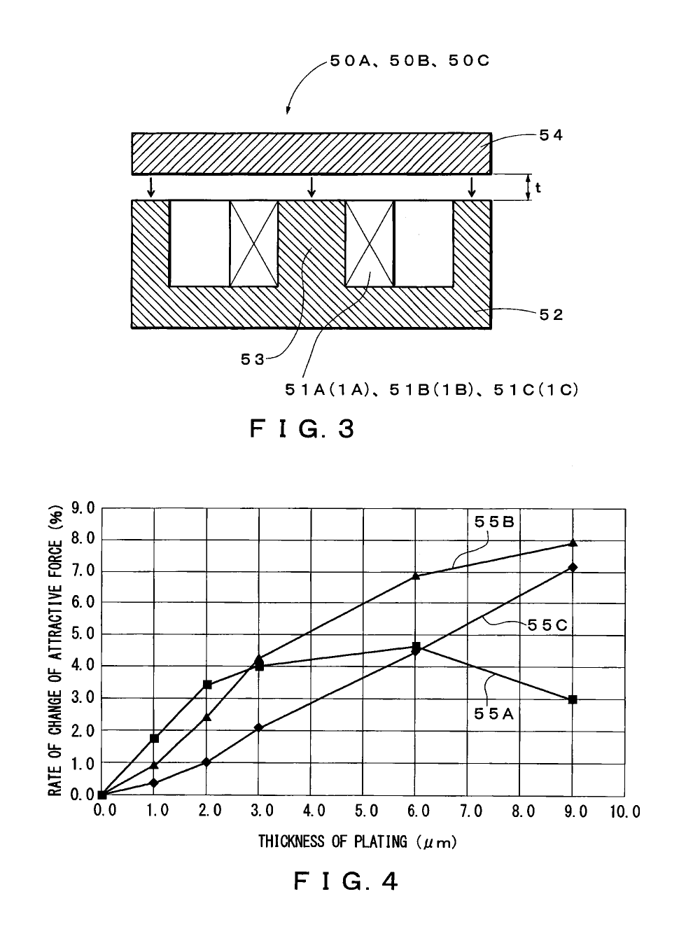

An attraction experiment of a solenoid 50 using the wire rod for electromagnet 1 of the present embodiment will now be described with reference to FIGS. 3 and 4. This example is an experimental verification of an effect of increasing an attractive force of the solenoid 50 (an increase in a torque) when a material and a thickness of the magnetic layer of the wire rod for electromagnet 1 are changed.

In the related art, as a wire rod for electromagnet, a wire rod that has only an insulating layer outside an electric conductor has been used. However, a wire rod provided with the magnetic layer 3 outside the electric conductor 2 as in the present embodiment has not been used. This is because 1) it has been generally considered that providing the magnetic layer 3 does not contribute to an improvement in an attractive force of the solenoid 50, and 2) it results in an increased cost required for the wire rod. However, it is now found that an improvement in an attractive force of the solenoid 50 can be anticipated by actually using a wire rod for electromagnet 1 (11, 21) which is provided with a magnetic layer 3.

In this experiment, the following three types of the wire rod for electromagnet were examined.
(A) Wire rod for electromagnet 1A (wire size Φ0.5)
   Electric conductor: Mainly copper.
   Magnetic layer: Alloy of mainly Fe.
   Insulating enamel layer (35 μm) outwardly of the magnetic layer.
(B) Wire rod for electromagnet 1B (wire size Φ0.5)
   Electric conductor: Mainly copper.
   Magnetic layer: Fe-50Ni with heat treatment.
   Insulating enamel layer (35 μm) outwardly of the magnetic layer.
(C) Wire rod for electromagnet 1C (wire size Φ0.5)
   Electric conductor: Mainly copper.
   Magnetic layer: Fe-80Ni without heat treatment.
   Insulating enamel layer (35 μm) outwardly of the magnetic layer.
      Note that in the description below, alphabets A, B and C accompanying the numerals correspond to the aforementioned wire rods for electromagnet (A), (B) and (C), respectively.

Initial permeabilities of the wire rods for electromagnet 1A, 1B and 1C were 100, 2000 and 500, respectively, expressed in relative permeability.

Saturation flux densities (T) of the wire rods for electromagnet 1A, 1B, and 1C were 2.0 (T), 1.5 (T) and 0.75 (T), respectively.

As shown in FIG. 3, a coil 51A of a solenoid 50A was formed by winding 17 turns of the wire rod for electromagnet 1A on a fixed iron core 52 (diameter of core 53: Φ6 mm) having an E-shaped cross-section. As an electromagnetic steel plate 54 to be attracted, 45JN1600 manufactured by JFE

Steel Corporation was used. Further, a gap t between the coil 51 and the electromagnetic steel plate 54 was set at 1 mm.

Similarly, the solenoids 50B and 50C have the same basic structure and the only difference is their wire rods (material of the magnetic layer).

Using such an arrangement, a change in an attractive force was examined for cases where a film thickness (thickness of plating) of the magnetic layer 3 was changed between 1.0 μm, 2.0 μm, 3.0 μm, 6.0 μm and 9.0 μm. A current density was 5 A/mm². A result of the experiment is shown in FIG. 4. In this graph, a horizontal axis represents a thickness of plating (pm) and a vertical axis represents a rate of change of attractive force (%) for a coil using a wire rod without a magnetic layer, and the rate of change of attractive force was plotted for each thickness of plating. In the graph of FIG. 4, reference numeral 55A indicates data of a solenoid 50A that uses the wire rod for electromagnet 1A, reference numeral 50B indicates data of a solenoid 50B that uses the wire rod for electromagnet 1B, and reference numeral 50C indicates data of a solenoid 50C that uses the wire rod for electromagnet 1C.

From the graph of FIG. 4, for each of the wire rods for electromagnet 1A, 1B and 1C, it was found that: (1) since the rate of change of attractive force has a positive value, an attractive force can be increased by providing the magnetic layer; (2) the value of the rate of change of attractive force differs depending on the material of the magnetic layer 3; and (3) the value of the rate of change of attractive force differs depending on the film thickness of the magnetic layer.

Further, the followings can be determined from the graph of FIG. 4.

(i) In the case of the wire rod for electromagnet 1A (reference numeral 55A in the graph of FIG. 4), it was found that the rate of change of attractive force is greater than or equal to 1% when the film thickness of the magnetic layer is greater than or equal to 0.6 μm, and the rate of change of attractive force has a greatest value of 4.5% when the film thickness of the magnetic layer is 6.0 μm. It was also found that when the film thickness is greater than 6.0 μm, the rate of change of attractive force tends to decrease from the greatest value.

(ii) In the case of the wire rod for electromagnet 1B (reference numeral 55B in the graph of FIG. 4), it was found that the rate of change of attractive force increases along with an increase in the film thickness of the magnetic layer and the rate of change of attractive force is greater than or equal to 1% when the film thickness is greater than or equal to 1.0 μm, and that the rate of change of attractive force has a greatest value of 8.0% when the film thickness of the magnetic layer is 9.0 μm. It was also found that it is likely to be able to achieve a further increase in the attractive force by making the film thickness to be greater than 9.0 μm. Further, it is predicted that the greatest value is likely to be obtained with a certain thickness of plating which is greater than 9.0 μm, and at a thickness exceeding the certain thickness, the attractive force may drop as in the aforementioned (A).

(iii) In the case of the wire rod for electromagnet 1C (reference numeral 55C in the graph of FIG. 4), it was found that the rate of change of attractive force increases along with an increase in the film thickness of the magnetic layer, the rate of change of attractive force is greater than or equal to 1% when the film thickness is greater than or equal to 2.0 μm, and that the attractive force changes by 7.2% at the greatest value when the film thickness of the magnetic layer is 9.0 μm. It was also found that it is likely to be able to achieve a further increase in the attractive force by making the film thickness to be greater than 9.0 μm. Further, it is predicted that the greatest value is likely to be obtained with a certain thickness of plating which is greater than 9.0 μm, and at a thickness exceeding the certain thickness, the attractive force may drop as in the aforementioned (A).

(iv) The experiment was made for three types of materials, i.e., an alloy of mainly Fe, an Fe-50Ni alloy, and an Fe-80Ni alloy, and an improvement in the rate of change of attractive force was achieved for each of the above cases in comparison to a case in which the magnetic layer 3 (13, 23) is not provided. Thus, the rate of change of attraction can be improved by providing a magnetic layer 3 (13, 23) made of an alloy containing Ni such as an Fe—Ni alloy.

(v) From the graph of FIG. 4, it can be estimated that, by making a film thickness of the magnetic layer 3 (13, 23) to be at least greater than 0 μm (does not include 0 μm), the attractive force improves in comparison to a case in which the magnetic layer 3 (13, 23) is not provided.

(vi) From the graph of FIG. 4, it is estimated that, for any of the alloys, the saturation magnetic flux density has a large influence up to a point where the thickness of plating of the magnetic layer 3 is about 3.0 μm, and, an influence of the initial permeability gradually increases when the thickness of plating of the magnetic layer 3 is greater than or equal to 3.0 μm.

(vii) It was found that, when the saturation magnetic flux density is 0.75 T to 2.0 T (correspond to 55C, 55B and 55A) and the thickness of plating of the magnetic layer 3 is greater than 0 μm and less than or equal to 6.0 μm, the rate of change of attractive force increases as the thickness of plating increases. It was also found that, when the saturation magnetic flux density is 0.75 T to 2.0 T and the thickness of plating of the magnetic layer 3 is greater than 0 μm and less than or equal to 3.0 μm, an amount of increase in the rate of change of attractive force with respect to the thickness of plating becomes greater than the cases of 3.0 μm to 6.0 μm.

(viii) It was found that, when the saturation magnetic flux density is 1.5 T to 2.0 T (corresponds to 55B and 55A) and the thickness of plating is greater than 0 μm and less than or equal to 6.0 μm, the rate of change of attractive force for each thickness of plating is greater than the case in which the saturation magnetic flux density is 0.75 T (corresponds to 55C). Specifically, it was found that, when the saturation magnetic flux density is 1.5 T to 2.0 T and the thickness of plating of the magnetic layer 3 is greater than 0 μm and less than or equal to 3.0 μm, the rate of change of attractive force for each thickness of plating is greater than double the rate of change of attractive force for the case where the saturation magnetic flux density is 0.75 T.

Also, it was found that when the saturation magnetic flux density is 1.5 T to 2.0 T and the film thickness is greater than 0 μm and less than or equal to 3.0 μm, an amount of increase in the rate of change of attractive force with respect to the thickness of plating becomes greater than the case of 3.0 pm to 6.0 μm.

(ix) In the aforementioned (vii) and (viii), although the initial permeability was 100 to 2000, since there is a tendency that the saturation magnetic flux density has a large influence in a range of the thickness of plating of greater than 0 μm and less than or equal to 6.0 μm, it suffices if the initial permeability is greater than or equal to 100.

(x) In the aforementioned (vi) to (ix), it is more preferable to set a lower limit of the thickness of plating at 1.0 μm.

(xi) Since it is difficult to form a plating with some thickness, within a range in which an amount of increase in the rate of change of attractive force with respect to the thickness of plating is large, the plating can be easily manufactured with a reduced thickness, and an attractive force can be obtained effectively. As has been described above, the saturation magnetic flux density has an improvement effect at greater than or equal to 0.75, and the effect appears more significantly at greater than or equal to 1.5.

(xii) When the initial permeability is 500 to 2000, the thickness of plating is preferably 3.0 μm to 9.0 μm (corresponds to 55B and 55C), and the thickness of plating is more preferably 6.0 μm to 9.0 μm.

(xiii) In the above (xii), further, although the saturation magnetic flux density may be greater than or equal to 0.75 and less than or equal to 1.5, since an influence of the initial permeability increases in a range of thickness of plating of 3.0 μm to 9.0 μm, it suffices if the saturation magnetic flux density is greater than or equal to 0.75.

In a case where a thickness of plating is within the range of 3.0 μm to 9.0 μm, as has been described above, since an influence of the initial permeability is greater than an influence of the saturation magnetic flux density, a greater effect in an improvement of an attractive force can be obtained by providing a large value for the saturation magnetic flux density and then providing the thickness of plating within the range. With the thickness of plating being 6.0 μm to 9.0 μm, in a case of an Fe—Ni alloy, a greater effect in an improvement of the attractive force can be obtained as compared to a case of an alloy containing Fe as a major component.

In the present embodiment, an Fe-Ni alloy was used for forming the magnetic layer. However, it is not limited thereto, and an effect similar to the effect described above can be obtained when an alloy with other metals such as FeCo, FeAlSi or FeNiMo is used.

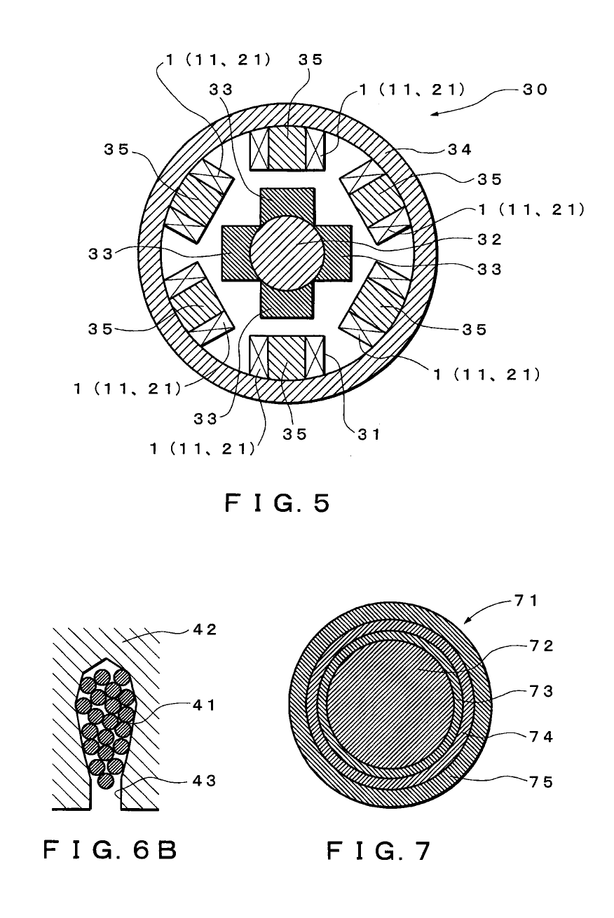

Hereinafter, a motor using the wire rod for electromagnet 1 of the present embodiment will be described with reference to FIGS. 5 and 6. FIG. 5 is a schematic diagram indicating a case in which the wire rod for electromagnet 1 (11, 21) is used for a stator 31 of a motor 30. The motor 30 shown in FIG. 5 is a concentrated winding motor.

The motor 30 is provided with four rotors 33 provided on an outer periphery of a rotation shaft 32 and a stator 31 attached on a housing 34 side of the motor. A core 35 of the stator 31 is integral with the housing 34 and is configured in such a manner that the wire rod for electromagnet 1 (11, 21) is directly wound on the core 35.

FIGS. 6A and 6B show a configuration in which the wire rod for electromagnet 1 (11, 21) is applied in a distributed winding motor 40. In FIGS. 6A and 6B, components similar to those shown in FIG. 5 are indicated with the same reference numerals.

The motor 40 has a stator core 41 that is provided as a body which is separate from a housing 42. In other words, the wire rod for electromagnet 1 (11, 21) is wound around the stator core 41 in advance and the stator core 41 is attached on the housing 42 side. More specifically, as shown in FIGS. 6A and 6B, the wound up stator core 41 is embedded inside a slot 43 provided on the housing side 42.

In this manner, the wire rod for electromagnet 1 (11, 21) can be applied to either of a concentrated winding motor 30 and a distributed winding motor 40. Also, these motors can be applied to a so-called direct current motor (DC brushless motor) or to an alternating current motor (induction motor).

According to the wire rod for electromagnet of an embodiment of the present disclosure, since the magnetic layer 3 (13, 23) is provided on a surface of the electric conductor 2 (12, 22), an electromagnetic force of the electromagnet can be improved. Thereby, an attractive force of the solenoid 50A (50B, 50C) can be improved, and, for example, when applied to a brake, an open-close force (attractive force) of the brake can be improved.

The magnetic layer 3 (13, 23) is made of an alloy of two or more elements containing Fe of greater than or equal to 10% by weight. Preferably, since the magnetic layer 3 (13, 23) is made of an Fe-50Ni alloy or an Fe-80Ni alloy, the magnetic layer 3 (13, 23) can be easily formed by plating or the like.

On the other hand, since the film thickness of the magnetic layer 3 (13, 23) of an Fe-50Ni alloy is 1.0 μm to 9.0 μm, the rate of change of attraction can be made to be greater than or equal to 1%. More preferably, since the film thickness is 3.0 μm to 9.0 μm, the rate of change of attractive force can be increased in comparison to a case using the wire rod for electromagnet 1A of the aforementioned (A) and an attractive force using the electromagnet such as the solenoid can be improved.

Also, since the film thickness of the magnetic layer 3 (13, 23) of the Fe-80Ni alloy is 2.0 μm to 9.0 μm, a rate of change of attraction can be made to be greater than or equal to 1%. Further, more preferably, since it is 6.0 μm to 9.0 μm, the rate of change of attractive force can be increased in comparison to a case in which the wire rod for electromagnet 1A of the aforementioned (A) is used and an attractive force using the electromagnet such as the solenoid can be improved.

Further, since the magnetic layer 3 (13, 23) is an alloy mainly containing Fe and its film thickness is 0.6 μm to 9.0 μm and more preferably 1.0 μm to 6.0 μm, it will not be plated to exceed the film thickness 6.0 μm at which the rate of change of attraction is largest. Since it is preferable to reduce the thickness of the plating, the film thickness can be prevented from becoming unnecessarily thick.

Also, since the magnetic layer 3 (13, 23) is an alloy mainly containing Fe and its film thickness is made to be 0.6 μm to 3.0 μm and more preferably 1.0 μm to 3.0 μm, the rate of change of attraction can be improved in comparison to a case in which the magnetic layer 3 is made of an Fe-50Ni alloy or an Fe-80Ni alloy, and an attractive force of a solenoid or the like that uses an electromagnet can be improved.

On the other hand, since the magnetic layer 3 (13) is provided between the electric conductor 2 (12) and the insulating layer 4 (14), the magnetic layer 3 (13) can be easily formed by plating on the electric conductor 2 (12) made of copper.

In the first embodiment described above, the magnetic layer 3 (13, 23) made of an alloy containing a predetermined amount of Fe metal was taken as an example. In addition, the inventors have found that an attractive force can be increased in a case where the magnetic layer is made of Fe as compared to a case where the wire rod for electromagnet is provided with no magnetic layer.

FIG. 7 is a cross-sectional view showing a configuration of a wire rod for electromagnet of a second embodiment of the present disclosure. Since the configuration of the wire rod for electromagnet of the present embodiment is basically the same as the configuration of the wire rod for electromagnet of the first embodiment, different parts will be described below.

A wire rod for electromagnet 71 includes an electric conductor 72 which is a core of the wire rod, a magnetic layer 73 covering the electric conductor 72 on an outer side, a metal layer 74 covering the magnetic layer 73 on an outer side, and an insulating layer 75 that covers the metal layer 74 on an outer side. In other words, the magnetic layer 73 is provided between the electric conductor 72 and the metal layer 74. In this embodiment, a wire size of the wire rod for electromagnet 71 is, for example, Φ0.5.

The magnetic layer 73 is made of a magnetic layer which is a film made of Fe as a single element. The film thickness of the magnetic layer is greater than 0 μm and less than or equal to 3.0 μm and preferably greater than or equal to 1.5 μm and less than or equal to 3.0 μm. The metal layer 74 is preferably formed with a thickness of an order of several μm, and, for example, made of Ni.

The saturation magnetic flux density of the magnetic layer 73 (a layer made of Fe as a single element) is 2.15 T. Since an influence of the saturation magnetic flux density increases when the film thickness is greater than 0 μm and less than or equal to 3 μm, it is estimated that the rate of change of attractive force when a film made of Fe as a single element is formed indicates a similar characteristics for a case where a film mainly made of Fe is formed.

FIG. 8 is a cross-sectional view of a solenoid for examining an attractive force of an electromagnet.

As shown in FIG. 8, coils 81a and 81b of a solenoid 80 are formed by winding 150 turns of a wire rod for electromagnet 81 around cores 83a and 83b, respectively, of a fixed iron core 82 having a substantially U-shaped cross section, and an inner diameter of the coils 81a and 81b is Φ20. A gap t′ between the coils 81a, 81b and an electromagnetic steel plate 84 whereto a load cell 85 is attached is, for example, 1.0 mm or 2.0 mm.

In an arrangement configured as described above, a relationship between an electric current and an attractive force and a relationship between a film thickness of the magnetic layer and a rate of change of attractive force were examined for a case where a wire rod without a magnetic layer 83 is used or a case where a wire rod having a magnetic layer 83 of a film thickness of 1.5 μm or 3.0 μm is used. The results of the experiment are shown in FIGS. 9A and 9B. In FIG. 9A, a horizontal axis represents an electric current (A) and a vertical axis represents an attractive force (N), and, an attractive force is plotted for each magnitude of an electric current. In FIG. 9A, for the case of gap t′=1.0 mm, reference numeral 91 indicates data of a solenoid which is provided with no magnetic layer 83, reference numeral 92 indicates data of a solenoid using the wire rod having the magnetic layer 83 of a film thickness of 1.5 μm, and reference numeral 93 indicates data of a solenoid using a wire rod having the magnetic layer 83 of a film thickness 3.0 μm. For a case of gap t′=2.0 mm, reference numeral 94 indicates a solenoid which is provided with no magnetic layer 83, reference numeral 95 indicates a solenoid using the wire rod having the magnetic layer 83 of a film thickness of 1.5 μm, reference numeral 96 indicates data of a solenoid using the wire rod having the magnetic layer 83 of a film thickness of 3.0 μm.

As shown in FIG. 9A, for each of cases where the gap t′ has a value of t′=1.0 mm (reference numerals 91, 92 and 93) and t′=2.0 mm (reference numerals 94, 95 and 96), it was found that an attractive force increases in response to an increase in an electric current. In a case where the gap t′ is constant, it was found that an attractive force can be increased when a wire rod is provided with a magnetic layer. On the other hand, it was found that when the film thickness of the magnetic layer is constant (e.g., reference numerals 92 and 95), an attractive force increases as a value of the gap t′ becomes smaller, and that an attractive force in a case where t′=1.0 mm shows a value of greater than or equal double the case where t′=2.0 mm.

In FIG. 9B, a horizontal axis represents an Fe film thickness (pm) and a vertical axis represents a rate of change of attractive force (%), and a rate of change of attractive force is plotted for every thickness of the Fe film is plotted. In FIG. 9B, a reference numeral 97 indicates data of a solenoid when gap t′=1.0 mm and a reference numeral 98 indicates data of a solenoid when gap t′=2.0 mm.

As shown in FIG. 9B, it was found that when the gap t′ is constant, the rate of change of attractive force can be increased when the film thickness of the magnetic layer is increased. Also, it was found that for a case where gap t′=1.0 mm (reference numeral 97 in the graph of FIG. 9B), the rate of change is approximately 1.8% when the film thickness is 1.5 μm and the rate of change is approximately 5.6% when the film thickness is 3.0 μm. It was found that for a case where gap t′=2.0 mm (reference numeral 98 in the graph of FIG. 9B), the rate of change is approximately 2.0% when the film thickness is 1.5 μm and the rate of change is approximately 11% when the film thickness is 3.0 μm. In addition, since the rate of change becomes larger for both of the gap values when the film thickness is greater than 1.5 μm, it can be estimated that the film thickness 1.5 μm is a critical value regarding the rate of change of attractive force.

According to the wire rod for electromagnet of the present embodiment, since the magnetic layer 73 is formed by a film made of Fe, the rate of change of attractive force can be improved as compared to a case where the magnetic layer 73 is not provided, and the attractive force of, for example, a solenoid using an electromagnet can improved. Further, since the magnetic layer 73 made of Fe has a film thickness of 1.5 μm to 3.0 μm, the rate of change of attractive force can be further improved.

In the present embodiment, the magnetic layer 73 is made of Fe. However, it is not limited thereto, and may be substantially made of Fe. With the present configuration, an effect similar to that of the above can be obtained.

The wire rod for electromagnet of an embodiment of the present embodiment has been described. However, the present disclosure is not limited to the aforementioned embodiment, and various modifications and alterations can be made based on a technical spirit of the present invention.

For example, in the present embodiment, a solenoid and a motor are described as exemplary products that use electromagnets. However, the present disclosure can be applied to other products as long as they are products that can improve performance by increasing an attractive force.

What is claimed is:

1. An electromagnet comprising a core and a wire wound on the core, the wire including an electric conductor and a magnetic layer provided on a surface of the electric conductor.

2. The electromagnet according to claim 1, wherein the magnetic layer is made of an alloy containing iron.

3. The electromagnet according to claim 2, wherein the alloy is an Fe—Ni alloy.

4. The electromagnet according to claim 1, wherein the magnetic layer is made of iron.

5. The electromagnet according to claim 2, wherein the magnetic layer has a film thickness of greater than 0 μm and less than or equal to 6.0 μm.

6. The electromagnet according to claim 2, wherein the magnetic layer has a film thickness of greater than 3.0 μm and less than or equal to 9.0 μm.

7. The electromagnet according to claim 4, wherein the magnetic layer has a film thickness of greater than 0 μm and less than or equal to 6.0 μm.

8. The electromagnet according to claim 4, wherein the magnetic layer has a film thickness of greater than 3.0 μm and less than or equal to 9.0 μm.

9. The electromagnet according to claim 1, wherein the magnetic layer is provided between the electric conductor and an insulating layer.

10. The electromagnet according to claim 1, wherein the magnetic layer is formed on a surface of the electric conductor by plating.

11. The electromagnet according to claim 1, wherein the electric conductor has a substantially rectangular cross-section.

12. A motor comprising:
a rotation shaft; and
a stator having the electromagnet of claim 1.

13. A solenoid comprising:
the electromagnet of claim 1; and
a magnetic body spaced apart from the electromagnet.

14. The solenoid according to claim 13, wherein the magnetic body is an electromagnetic steel plate.
